(19) United States
(12) Patent Application Publication
(10) Pub. No.: US 2014/0231695 A1
(43) Pub. Date: Aug. 21, 2014

(54) Syntactic Insulator with Co-Shrinking Fillers

(71) Applicant: POWDERMET, INC., Euclid, OH (US)

(72) Inventors: Brian P. Doud, Cleveland Heights, OH (US); Mark V. Grogan, Cleveland, OH (US); Andrew Sherman, Mentor, OH (US)

(73) Assignee: POWDERMET, INC., Euclid, OH (US)

(21) Appl. No.: 14/073,064

(22) Filed: Nov. 6, 2013

Related U.S. Application Data
(60) Provisional application No. 61/723,542, filed on Nov. 7, 2012.

(51) Int. Cl. F16L 59/02

(52) U.S. Cl. CPC F16L 59/028
USPC 252/62; 264/331.11

(57) ABSTRACT

A syntactic foam insulator with co-shrinkage in the form of an insulating material formed by the inclusion of microballoons in a matrix material such that the microballoons and the matrix material exhibit co-shrinkage upon processing. The syntactic foam insulator can be formed by a variety of microballoon-matrix material combinations such as polymer microballoons in a preceramic matrix material. The matrix materials generally contain fine, rigid fillers.

The present invention claims priority on U.S. Provisional Patent Application Ser. No. 61/723,542, filed Nov. 7, 2012, which is incorporated herein by reference.

### STATEMENT REGARDING FEDERALLY-SPONSORED RESEARCH OR DEVELOPMENT

Portions of this work were conducted under federally-sponsored research, including NASA SBIR contract NNX110E65P.

### FIELD OF INVENTION

The present invention is in the technical field of high temperature composite materials. More particularly, the present invention is in the technical field of structural, thermally-insulating composite materials. Still more particularly, the present invention is in the technical field of structural, thermally-insulating composite materials at least partially derived from preceramic polymers and reactive materials. Yet more particularly, the present invention is in the technical field of structural, thermally-insulating composite materials at least partially derived from preceramic polymers and reactive materials, which thermally-insulating composite materials incorporate hollow and/or shrinkable fillers.

### BACKGROUND OF THE INVENTION

Evolving requirements for dimensionally stable high temperature structures are driven by increased needs for speed and mobility in aerospace systems. Current insulators have limitations with regard to temperature and strength limits of low density insulator systems, poor thermal shock resistance and high density of ceramic systems including monolithic oxides and ceramic matrix composite materials, and lack of dimensional stability and high density of phenolic or other polymer based composite insulators. The current invention enables the production of a low density, high temperature structural insulator suitable for use in rocket motors and reentry vehicles, as well as metal processing and other high temperature applications.

### SUMMARY OF THE INVENTION

The present invention is directed to structural, thermally-insulating composite materials. In one non-limiting embodiment of the invention, the present invention is directed to structural, thermally-insulating composite materials that are at least partially derived from preceramic polymers and reactive materials. The thermally-insulating composite materials incorporate hollow and/or shrinkable fillers. The structural, thermally-insulating composite materials are generally a high strength composite insulator that protects against high temperatures and can be used in high stress environments up to and exceeding 1600° C.; however, this is not required. The structural, thermally-insulating composite materials can include designer hollow spherical fillers that co-shrink with a preceramic polymer matrix material to lower or eliminate stress during sintering, pyrolization, and/or curing. These hollow fillers can form pores in the material.

In one non-limiting aspect of the present invention, the thermally-insulating composite materials include individual pores distributed in a matrix material. The matrix pores can be evenly or non-evenly distributed in the matrix material. The pores are generally distributed throughout the matrix material and have a low thermal conductivity. As such, when the pores are distributed in the matrix material, the overall thermal conductivity of the thermally-insulating composite material is lower than the thermal conductivity of the matrix material. Generally the thermal conductivity of the pores (e.g., microspheres, etc.) is less than the matrix material (e.g., polymer, etc.). Generally, the plurality of pores in the matrix material exhibit co-shrinkage upon processing at elevated temperatures. This co-shrinkage can reduce post-processing stresses within the thermally-insulating composite material.

In another and/or alternative non-limiting aspect of the present invention, the thermally-insulating composite material can have varying degrees of size, loading, and/or distribution. The size of the one or more pores in the thermally-insulating composite material is non-limiting. In one non-limiting embodiment, the pore size can range from several nanometers to hundreds of microns. In another and/or alternative non-limiting embodiment of the present invention, the pore loading in the matrix material can range from less than 1% to up to about 74% by volume. The upper limit of about 74% by volume is the maximum achievable volume for a closed-cell porous system that can be successfully used in the present invention. In one non-limiting specific configuration, the pore loading in the matrix material is at least about 5% by volume of said thermally-insulating composite material. In another non-limiting specific configuration, the pore loading in the matrix material is at least about 25% by volume of said thermally-insulating composite material. In another non-limiting specific configuration, the pore loading in the matrix material is at least about 40% by volume of said thermally-insulating composite material. In another non-limiting specific configuration, the pore loading in the matrix material is over 50% by volume of said thermally-insulating composite material. In another non-limiting specific configuration, the pore loading in the matrix material is at least about 60% by volume of said thermally-insulating composite material. In still another and/or alternative non-limiting embodiment of the present invention, the distribution of pores in the matrix material can be random, gradient, and/or uniform. In one non-limiting specific configuration, the distribution of pores in the matrix material is generally uniform.

In still another and/or alternative non-limiting aspect of the present invention, the thermally-insulating composite material can include, by volume of said thermally-insulating composite material, a matrix material at least partially formed of polymer, ceramic, metal and/or any other sufficiently rigid and strong material; however, this is not required. The matrix material can also or alternatively be formed from a precursor material that converts to a solid polymer, ceramic, and/or metal matrix system upon curing, pyrolization, carbonization and/or any other reaction mechanism. The matrix material can optionally include nonshrinkable fillers in the form of fibers, nanofibers, and/or other toughening and strengthening reinforcements; however, this is not required.

In still yet another and/or alternative non-limiting aspect of the present invention, the thermally-insulating composite material can include one or more pores that are formed of micro-balloons of ceramic, metal, polymer, aerogel, and/or any material that exhibits co-shrinkage with the matrix material throughout processing; however, this is not required. The one or more pores in the matrix material generally provide high strength and/or low thermal conductivity; however, this is not required. One or more of the pores can optionally be entirely hollow and/or be formed by the inclusion and degradation of a ceramic, metal, polymer, and/or any material that degrades at high temperatures leaving closed-cell porosity; however, this is not required.

In yet another and/or alternative aspect of the present invention, there is provided a material and a method of manufacturing a material that comprises a thermally-insulating, syntactic composite material formed of pores that are or include low-density microspheres in a polymer-derived matrix material that exhibits co-shrinkage between the microspheres and polymer-derived matrix during processing. One or more of the microspheres can optionally include shrinkable hollow microballoons and/or shrinkable low-density aerogel particles. One or more of the shrinkable microspheres can include a preceramic polymer microballoon, phenolic resin microballoon, green or partially cured aerogel, and/or a sinterable ceramic microballoon. The matrix polymer material can optionally be a thermosetting preceramic polymer. The matrix phase can be engineered to have lower shrinkage than the syntactic filler such that it can be placed in compression upon curing; however, this is not required. The matrix phase can be optionally engineered to have the same shrinkage as the syntactic filler so as to have close to zero residual stress after curing and pyrolization; however, this is not required. The syntactic filler can have some shrinkage; however, this is not required. Any shrinkage is generally less than the matrix material so as to restrain the shrinkage of the matrix phase; however, this is not required. One non-limiting method for manufacturing a material that comprises a thermally-insulating, syntactic composite material formed from low density microspheres in a polymer-derived matrix material that exhibits co-shrinkage between the microspheres and polymer-derived matrix during processing can include the non-limiting steps of a) mixing shrinkable/curable microspheres and a thermosetting, curable polymer, b) molding and/or forming the mixed microspheres and polymer into a shape, and c) subsequently heat curing and pyrolization of the polymer material(s) to form the syntactic ceramic composite. The syntactic ceramic composite can optionally be subsequently processed with successive polymer impregnations and/or pyrolizations to increase density and/or strength. The syntactic ceramic composite can optionally undergo a stabilizing heat at or above the required operating temperatures. The method can optionally include the step of a non-shrinkable fiber filler being added to control matrix shrinkage. The non-shrinkable fiber fillers are or generally include fine, rigid fiber fillers. The fiber fillers generally have a principle dimension of at least about 2 times (i.e., 2×) smaller than the average diameter of the pores (i.e., microspheres), typically at least about 5 times (i.e., 5×) smaller than the average diameter of the pores, more typically at least about 10 times (i.e., 10×) smaller than the average diameter of the pores, still more typically at least about 15 times (i.e., 15×) smaller than the average diameter of the pores, and yet still more typically at least about 20 times (i.e., 20×) smaller than the average diameter of the pores. The non-shrinkable fiber fillers can include, but are not limited to, ceramic particles and fibers, whiskers, or nanotubes. Generally, the fiber fillers are used to control shrinkage and/or to increase toughness. The fiber fillers can also be used to provide increased strength. The non-shrinkable filler phase of the matrix material can optionally have at least one primary dimension (e.g., length) of less than the pore diameter (e.g., diameter of microsphere). In one non-limiting arrangement, the average height of the non-shrinkable filler phase is less than average the pore diameter. In another non-limiting arrangement, the average length of the non-shrinkable filler phase is no more than about 90% of the average the pore diameter. In another non-limiting arrangement, the average length of the non-shrinkable filler phase is no more than about 80% of the average the pore diameter. In another non-limiting arrangement, the average length of the non-shrinkable filler phase is no more than about 60% of the average the pore diameter. In another non-limiting arrangement, the average length of the non-shrinkable filler phase is no more than about 50% of the average the pore diameter. In another non-limiting arrangement, the average length of the non-shrinkable filler phase is no more than about 30% of the average the pore diameter. In another non-limiting arrangement, the average length of the non-shrinkable filler phase is no more than about 20% of the average the pore diameter. In another non-limiting arrangement, the average length of the non-shrinkable filler phase is no more than about 5% of the average the pore diameter.

Non-limiting advantages of the present invention include 1) the ability to produce a closed-cell porous material with co-shrinkage between the pore material and matrix material, and 2) the ability to produce a closed-cell porous material with co-shrinkage between the pore material and matrix material which may include rigid fillers, such as fibers in the matrix material. These advantages and others can be achieved through the use of one or more pores that are at least partially formed of a polymer microballoon and/or any other microballoon or material that exhibits co-shrinkage with the matrix precursor upon processing. Current state of the art does not achieve this co-shrinkage, leading to stress build up in the material and overall loss of strength. The present invention instead retains its strength and/or structural integrity throughout processing.

In summary, there is provided one non-limiting method of manufacturing of a thermally-insulating, syntactic composite material that includes one or more pores that are formed from low density microspheres in a polymer-derived matrix material that exhibits co-shrinkage between the microspheres and polymer-derived matrix during processing, which method includes a) mixing the shrinkable/curable microspheres and a thermosetting, curable polymer; b) molding or forming the mixed microspheres and polymer into a shape; and, c) subsequent heat curing and pyrolization of the polymer material(s) to form a syntactic ceramic composite. The syntactic ceramic composite can optionally be subsequently processed with successive polymer impregnations and/or pyrolizations to increase density and/or strength. The syntactic ceramic composite can optionally undergo a stabilizing heat at or above the required operating temperatures. The syntactic ceramic composite can optionally include a non-shrinkable filler to control matrix shrinkage. The syntactic ceramic composite can optionally include fibrous materials to provide higher strength and/or toughness. The syntactic ceramic composite can optionally be engineered so that the matrix material has a lower shrinkage than the syntactic filler such that it is placed in compression upon curing. The syntactic ceramic composite can optionally be engineered so that the matrix material has the same shrinkage as the syntactic filler so as to be close to zero residual stress after curing and pyrolization. The syntactic ceramic composite can optionally include syntactic filler that has some shrinkage, but it is less than the shrinkage of the matrix material so as to restrain the shrinkage of the matrix phase.

It is one non-limiting object of the present invention to provide an improved structural, thermally-insulating composite material.

It is another and/or alternative non-limiting object of the present invention to provide a structural, thermally-insulating composite material that is at least partially derived from preceramic polymers and reactive materials.

It is still another and/or alternative non-limiting object of the present invention to provide a structural, thermally-insulating composite material that incorporates hollow and/or shrinkable fillers.

It is yet another and/or alternative non-limiting object of the present invention to provide a structural, thermally-insulating composite material that protects against high temperatures and can be used in high-stress environments up to and exceeding 1600° C.

It is still yet another and/or alternative non-limiting object of the present invention to provide a structural, thermally-insulating composite material that includes designer hollow spherical fillers that co-shrink with a preceramic polymer matrix material to lower or eliminate stress during sintering, pyrolization, and/or curing.

It is another and/or alternative non-limiting object of the present invention to provide a structural, thermally-insulating composite material with pores distributed in a matrix material, which pores can be evenly or non-evenly distributed in the matrix material.

It is still another and/or alternative non-limiting object of the present invention to provide a structural, thermally-insulating composite material that includes pores that have a low thermal conductivity.

It is yet another and/or alternative non-limiting object of the present invention to provide a structural, thermally-insulating composite material that has an overall thermal conductivity that is lower than the thermal conductivity of the matrix material.

It is still yet another and/or alternative non-limiting object of the present invention to provide a structural, thermally-insulating composite material that includes pores in the matrix material that exhibit co-shrinkage upon processing at elevated temperatures.

It is another and/or alternative non-limiting object of the present invention to provide a structural, thermally-insulating composite material that has varying degrees of size, loading, and/or distribution.

It is still another and/or alternative non-limiting object of the present invention to provide a structural, thermally-insulating composite material that has pore loading in the matrix material that ranges from less than 1% to up to about 74% by volume.

It is yet another and/or alternative non-limiting object of the present invention to provide a structural, thermally-insulating composite material that has a pore distribution in the matrix material that is random, gradient, or uniform.

It is still yet another and/or alternative non-limiting object of the present invention to provide a structural, thermally-insulating composite material that includes a matrix material that is at least partially formed of polymer, ceramic, metal and/or any other sufficiently rigid and strong material.

It is another and/or alternative non-limiting object of the present invention to provide a structural, thermally-insulating composite material wherein the matrix material can be at least partially formed from a precursor material that converts to a solid polymer, ceramic, and/or metal matrix system upon curing, pyrolization, carbonization and/or any other reaction mechanism.

It is still another and/or alternative non-limiting object of the present invention to provide a structural, thermally-insulating composite material that optionally includes a filler such as, but not limited to, fibers, nanofibers, and/or other toughening and/or strengthening reinforcement.

It is yet another and/or alternative non-limiting object of the present invention to provide a structural, thermally-insulating composite material that includes one or more pores that are formed of microballoons of ceramic, metal, polymer, aerogel, and/or any material that exhibits co-shrinkage with the matrix material throughout processing.

It is still yet another and/or alternative non-limiting object of the present invention to provide a structural, thermally-insulating composite material that includes one or more pores in the matrix material that provide high strength and/or low thermal conductivity.

It is another and/or alternative non-limiting object of the present invention to provide a structural, thermally-insulating composite material that includes one or more of the pores that are entirely hollow and/or are formed by the inclusion and degradation of a ceramic, metal, polymer, and/or any material that degrades at high temperatures leaving closed-cell porosity.

It is still another and/or alternative non-limiting object of the present invention to provide a structural, thermally-insulating composite material wherein the non-shrinkable filler phase of the matrix material has a primary dimension (e.g., height, width) that is less than the pore diameter (e.g., diameter of microsphere).

It is yet another and/or alternative non-limiting object of the present invention to provide a structural, thermally-insulating composite material that has the ability to produce a closed-cell porous material with co-shrinkage between the pore material and matrix material, and the ability to produce a closed-cell porous material with co-shrinkage between the pore material and matrix material which may include rigid fillers such as fibers in the matrix material.

It is still yet another and/or alternative non-limiting object of the present invention to provide a structural, thermally-insulating composite material that retains its strength and/or structural integrity throughout processing.

It is another and/or alternative non-limiting object of the present invention to provide a structural, thermally-insulating composite material that contains fine, rigid fillers with a principle dimension that is smaller than the microballoons, and where such fillers can optionally include ceramic particles and fibers, whiskers, or nanotubes, and in which such filler can optionally be used to control shrinkage and increase toughness of the structural, thermally-insulating composite materials.

It is still another and/or alternative non-limiting object of the present invention to provide a method for manufacturing a structural, thermally-insulating composite material that comprises a) mixing shrinkable/curable microspheres and a thermosetting, curable polymer, b) molding and/or forming the mixed microspheres and polymer into a shape, and c) subsequently heat curing and pyrolization of the polymer material(s) to form the syntactic ceramic composite.

It is yet another and/or alternative non-limiting object of the present invention to provide a method for manufacturing a structural, thermally-insulating composite material that includes subsequent processing of the structural, thermally-insulating composite material with successive polymer impregnations and/or pyrolizations to increase density and/or strength.

It is still yet another and/or alternative non-limiting object of the present invention to provide a method for manufacturing a structural, thermally-insulating composite material that includes subsequent processing of the structural, thermally-insulating composite material with a stabilizing heat at or above the required operating temperatures.

These and other objects and advantages will become apparent to those skilled in the art upon reading and following the description taken together with the accompanying drawings.

### BRIEF DESCRIPTION OF THE DRAWINGS

Reference may now be made to the drawing which illustrates a non-limiting embodiment that the invention may take in physical form and in certain parts and arrangement of parts wherein:

FIG. 1 is a side view of a cross section of a closed-cell foam insulator of the present invention.

### DETAILED DESCRIPTION OF THE INVENTION

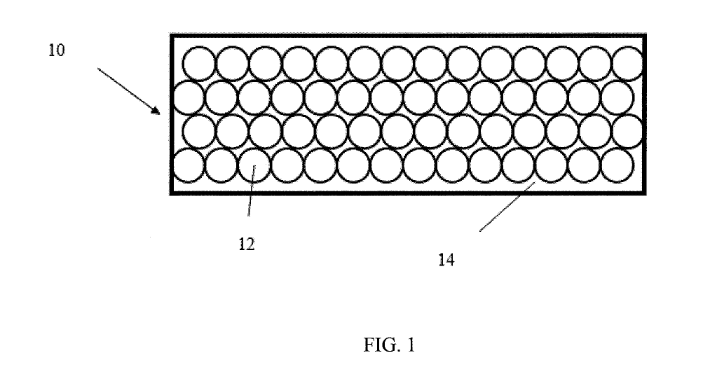

Referring now to the drawing, wherein the showing is for the purpose of illustrating of a preferred embodiment of the invention only and not for the purpose of limiting same, there is shown in FIG. 1 a cross section of a structural, thermally-insulating composite material in the form of a syntactic foam insulator 10 having individual pores 12 distributed in a matrix material 14.

The pores 12 that are distributed throughout the matrix material 14 have a low thermal conductivity. When the pores 12 are distributed in the matrix material 14, the overall thermal conductivity of the syntactic foam insulator system 10 is significantly lower than that of the matrix material 14. Additionally, one advantage of the invention is that the pores 12 and the matrix material 14 exhibit co-shrinkage upon processing at elevated temperatures. This co-shrinkage reduces post-processing stresses within the foam insulator system 10.

The syntactic insulator system 10 can have varying degrees of size, loading, and/or distribution. Pore 12 size can range from several nanometers to hundreds of microns. Pore 12 loadings can range from less than 1% to 74% by volume. The distribution of pores can be random, gradient, and/or uniform.

The foam insulator 10 can consist of or include a matrix material 14 made of polymer, ceramic, metal and/or any other sufficiently rigid and strong material. The matrix material can also be formed from a precursor material that converts to a solid polymer, ceramic, and/or metal matrix system upon curing, pyrolization, carbonization and/or any other reaction mechanism, and may include filler such as fibers, nanofibers, and/or other toughening and/or strengthening reinforcements. The pores 12 can be formed from a filler such as microballoons of ceramic, metal, polymer, aerogel, and/or any material that exhibit co-shrinkage with the matrix material 14 throughout processing. The pores generally provide high strength and/or low-thermal conductivity. The pores 12 can also be entirely hollow and or be formed by the inclusion and degradation of a ceramic, metal, polymer, and/or any material that degrades at high temperatures leaving closed-cell porosity.

The foam insulator 10 can be formed from low-density microspheres in a polymer-derived matrix material that exhibits co-shrinkage between the microspheres and polymer derived matrix during processing. One or more of the microspheres can optionally include shrinkable hollow microballoons and/or shrinkable low density aerogel particles. One or more of the shrinkable microspheres can include a preceramic polymer microballoon, phenolic resin microballoon, green or partially-cured aerogel, and/or a sinterable ceramic microballoon. The matrix polymer material can optionally be a thermosetting preceramic polymer. The matrix phase can be engineered to have lower shrinkage than the syntactic filler such that it can placed in compression upon curing. The matrix phase can be optionally engineered to have the same shrinkage as the syntactic filler so as to be close to zero residual stress after curing and pyrolization. The syntactic filler can have some shrinkage. Any shrinkage is generally less than the matrix material so as to restrain the shrinkage of the matrix phase. The foam insulator 10 can be manufactured by the steps of a) mixing shrinkable/curable microspheres and a thermosetting, curable polymer, b) molding and/or forming the mixed microspheres and polymer into a shape, and c) subsequently heat curing and pyrolization of the polymer material(s) to form a syntactic ceramic composite. The syntactic ceramic composite can optionally be subsequently processed with successive polymer impregnations and/or pyrolizations to increase density and/or strength. The syntactic ceramic composite can undergo a stabilizing heat at or above the required operating temperatures. The method can optionally include the step of a non-shrinkable filler being added to control matrix shrinkage. The method can optionally include the step of fibrous materials being added to provide higher strength and/or toughness. The non-shrinkable filler phase can optionally have at least one primary dimension (e.g., length) of less than 20% of the microsphere diameter, and typically less than 5% of the microsphere diameter.

It will thus be seen that the objects set forth above, among those made apparent from the preceding description, are efficiently attained, and since certain changes may be made in the constructions set forth without departing from the spirit and scope of the invention, it is intended that all matter contained in the above description and shown in the accompanying drawings shall be interpreted as illustrative and not in a limiting sense. The invention has been described with reference to preferred and alternate embodiments. Modifications and alterations will become apparent to those skilled in the art upon reading and understanding the detailed discussion of the invention provided herein. This invention is intended to include all such modifications and alterations insofar as they come within the scope of the present invention. It is also to be understood that the following claims are intended to cover all of the generic and specific features of the invention herein described and all statements of the scope of the invention, which, as a matter of language, might be said to fall there between. The invention has been described with reference to the preferred embodiments. These and other modifications of the preferred embodiments as well as other embodiments of the invention will be obvious from the disclosure herein, whereby the foregoing descriptive matter is to be interpreted merely as illustrative of the invention and not as a limitation. It is intended to include all such modifications and alterations insofar as they come within the scope of the appended claims.

What is claimed:

1. A method of manufacturing a thermally-insulating composite material formed from a shrinkable filler in a polymer-derived matrix material that exhibits co-shrinkage between the shrinkable filler and polymer-derived matrix during processing, which method includes:
a. mixing the shrinkable filler and a thermosetting, curable polymer, said shrinkable filler including microspheres;
b. molding or forming the mixed shrinkable filler and thermosetting, curable polymer into a shape; and,
c. heat curing and pyrolization of said mixed shrinkable filler and thermosetting, curable polymer to form a syntactic ceramic composite.

2. The method as defined in claim 1, wherein one or more of said microspheres are selected from the group consisting of shrinkable hollow microballoons and shrinkable low-density aerogel particles.

3. The method as defined in claim 1, including the step of subsequently processing said syntactic ceramic composite with successive polymer impregnations, pyrolizations, or combinations thereof to increase density, strength, or combinations thereof.

4. The method as defined in claim 1, including the step of subsequently processing said syntactic ceramic composite with a stabilizing heat at or above the required operating temperatures.

5. The method as defined in claim 1, including the step of adding a non-shrinkable filler to said polymer to control matrix shrinkage.

6. The method as defined in claim 5, wherein said non-shrinkable filler includes a fibrous material to provide higher strength, increased toughness, or combinations thereof.

7. The method as defined in claim 6, wherein the non-shrinkable fiber filler phase has a length of less than 20% of a diameter of said microspheres.

8. The method as defined in claim 1, wherein said shrinkable microspheres are selected from the group consisting of a preceramic polymer microballoon, phenolic resin microballoon, green or partially cured aerogel, and a sinterable ceramic microballoon.

9. The method as defined in claim 1, wherein said thermosetting, curable polymer has lower shrinkage than said shrinkable filler so as to place said thermosetting, curable polymer in compression upon said curing and pyrolization.

10. The method as defined in claim 1, wherein said thermosetting, curable polymer has the same shrinkage as said shrinkable filler so as to place said thermosetting, curable polymer in close to zero residual stress after said curing and pyrolization.

11. The method as defined in claim 1, wherein said thermosetting, curable polymer has greater shrinkage than said shrinkable filler to restrain said thermosetting, curable polymer from shrinkage after said curing and pyrolization.

12. A thermally-insulating composite material formed from a shrinkable filler in a polymer-derived matrix material that exhibits co-shrinkage between the shrinkable filler and polymer-derived matrix during processing, said polymer including a thermosetting, curable polymer, said shrinkable filler including microspheres, said microspheres formed of a material that co-shrinks with said polymer to lower or eliminate stress during sintering, pyrolization, curing, or combinations thereof of said polymer, said microspheres having a low thermal conductivity such that an overall thermal conductivity of said composite material is lower than a thermal conductivity of said polymer.

13. The composite material as defined in claim 12, a loading of said pores in said polymer is about 1-74% by volume of said composite material.

14. The composite material as defined in claim 12, wherein said distribution of said pores in said polymer is generally uniform.

15. The composite material as defined in claim 12, further including nonshrinkable fillers, said nonshrinkable fillers selected from the group consisting of fibers, whiskers, nanofibers, and nanotubes.

16. The composite material as defined in claim 12, wherein said nonshrinkable fillers have an average length that is less than an average diameter of said microspheres.

17. The composite material as defined in claim 12, wherein said microspheres include microballoons of ceramic, metal, polymer, aerogel, phenolic resin, or combinations thereof.

18. The composite material as defined in claim 12, wherein said microspheres have a different shrinkage than said polymer material.

19. The composite material as defined in claim 12, wherein said microspheres have about the same shrinkage as said polymer material.

20. The composite material as defined in claim 12, wherein a plurality of said microspheres formed of a material that partially or fully disintegrates during the curing of said polymer to form a pore in said polymer that is partially or fully absent said microsphere after said polymer has substantially fully cured.

21. The composite material as defined in claim 12, wherein said material has a density below about 1.5 g/cc and a flexure and compressive strength exceeding about 5000 psig.

22. The composite material as defined in claim 21, wherein said material has a density below about 1 g/cc, and a flexure and compressive strength exceeding about 10,000 psig.

23. The composite material as defined in claim 12, wherein said material has a thermal conductivity of less than about 0.6 w/m·K, a Coefficient of thermal expansion below about 5 ppm/C, and an elastic modulus below about 15 MSI.

24. The composite material as defined in claim 13, wherein said material has a thermal conductivity of less than about 0.2 w/m·K, a Coefficient of thermal expansion below about 4 ppm/C, and an elastic modulus below about 10 MSI.
